(19) United States
(12) Patent Application Publication
(10) Pub. No.: US 2014/0298303 A1
(43) Pub. Date: Oct. 2, 2014

(54) METHOD OF PROCESSING PROGRAM AND PROGRAM

(71) Applicant: HITACHI, LTD., Tokyo (JP)

(72) Inventor: Yasusi KANADA, Tokyo (JP)

(73) Assignee: HITACHI, LTD., Tokyo (JP)

(21) Appl. No.: 14/229,461

(22) Filed: Mar. 28, 2014

(30) Foreign Application Priority Data
Mar. 29, 2013 (JP) 2013-072185

(51) Int. Cl. G06F 9/45

(52) U.S. Cl. CPC G06F 8/41
USPC 717/140

(57) ABSTRACT

A method of processing a program for achieving programming with a low dependency on a hardware is provided. A plurality of types of data representations are provided to a packet in accordance with a type of a memory storing the packet. When an operation is performed for the packet, the data representation provided to the packet is identified, and the processing is performed in accordance with the identified data representation. In this manner, the program with the low dependency on the hardware such as a memory can be developed. Also, in a method (compiler) of processing the program used for the development of the program, a precondition is recognized when the processing for the packet is performed, so that a speed of the created object program is increased.

### CROSS-REFERENCE TO RELATED APPLICATION

The present application claims priority from Japanese Patent Application No. 2013-072185 filed on Mar. 29, 2013, the content of which is hereby incorporated by reference into this application.

### TECHNICAL FIELD OF THE INVENTION

The present invention relates to a method of processing a program and relates to a program. More particularly, the present invention relates to a method of processing a program used for developing a program for setting or managing a computer network or a virtual network which bridges among a plurality of domains, and relates to the program.

### BACKGROUND OF THE INVENTION

First, a background technology will be explained with categorizing it into the following four items. That is, the first one is a technology relating to selective usage of a plurality of data representations in a compiler used for developing a program. The second one is a hardware technology used for enabling a network to be programmable. More particularly, the second one is a technology relating to selective usage of a network processor, an SRAM (Static Random Access Memory), and a DRAM (Dynamic Random Access Memory) used in the network processor. The third one is a software technology used for enabling a network to be programmable, and, more particularly, a technology relating to a high-level language. The last one is a network virtual technology that is more particularly, a technology used for enabling a network to be programmable.

First, the technology relating to the selective usage of the plurality of data representations in the compiler will be explained. It is considered that selective usage of hardware elements is one type of the selective usage of the plurality of data representations. U.S. Patent Document No. 6,457,172 (Patent Document 1) describes a method of selectively using the plurality of data representations in the compiler. In the method described in Patent Document 1, different modules (data representation implementor) are used for the different data representations, respectively. This method seems to be appropriate for when a specific data representation is consistently used. However, application of this method seems to be difficult when combination usage of the plurality of data representations is required.

Next, the hardware technology for enabling the network to be programmable, which is more particularly a technology of selectively using a network processor and a memory which are used in the network processor and which are more particularly an SRAM and a DRAM, will be explained.

In a high-speed multicore network processor, it is desired to store data in the SRAM for (high-speed) wire rate processing. However, a network processor or a system is generally not provided with an SRAM having such a memory capacity as being large enough to store (preserve) all of the entire packets during the processing. Therefore, only a descriptor of a packet which is important for the processing or a head part of the same is stored in the SRAM, and the remaining part or the entire packet is stored in the DRAM. For example, in a network processor “Octeon (Trade Mark)” of the Cavium, Inc., or a network processor “Tile-Gx (Trade Mark)” of the Tilera corporation, such processing as the above-described selective usage is performed on a hardware upon arrival of a packet. A reason why all of the entire packets are not stored in the SRAM as described above is that preparation of such a large memory capacity SRAM lead to increase in a cost.

Also, for the high-speed processing, it is desired on the hardware to perform a function of allocating a content of a packet to the SRAM or the DRAM and automatically storing the content of the packet therein and perform a processing of putting an order of output packets processed in parallel by the multicore in an input order or of queuing them. These functions are also achieved by the network processor such as the above-described Octeon (Trade Mark).

In such selective usage of either the SRAM or the DRAM, the memory capacity of the SRAM is limited, and therefore, such conventional consistent selective usage as the selective usage of the plurality of data representations in the compiler is difficult. For example, increase in a volume of pieces of data to be stored in the SRAM by a computation processing causes such a processing as partially moving the pieces of data to the DRAM, and therefore, it is difficult to consistently use the SRAM as a memory for storage. On the other hand, for calculation, it is required to move data stored in the DRAM to the SRAM, that is, a register or others. Therefore, it is also difficult to consistently use the DRAM as a memory.

Further, as the software technology for enabling the network to be programmable, more particularly, the technology relating to the high-level language, “Shangri-la” and “NetVM” will be described. First, explanations will be made about the Baker language that has been developed for a system called Shangri-la produced by the Intel corporation and others as disclosed in Chen, M. K., Xiao, Feng Li, Lian, R., Lin, J. H., Lixia Liu, Tao Liu, and Ju, R., “Shangri-La: Achieving High Performance from Compiled Network Applications while Enabling Ease of Programming”, 2005 ACM SIGPLAN Conference on Programming Language Design and Implementation (PLDI '05), pp. 224 to 236, 2005 (Non-Patent Document 1). By an assumption that a main body of the packet is stored in the DRAM while a descriptor of the packet is stored in the SRAM in the Baker language, a programmer can unconsciously recognize in which one of the DRAM or the SRAM the packet is stored. However, it is required to determine a data structure of the SRAM by the programmer, and the data structure depends on an architecture of the network processor. Further, the programmer has to write data transfer between the DRAM and the SRAM, and therefore, the programmer has to perform a cash operation.

Lastly, the network virtual technology that is particularly the technology for enabling the network to be programmable will be explained next. In a virtual infrastructure developed in the “Virtual Node Project” promoted by the National Institute of Information and Communications Technology (Independent Administrative Agency), when a slice definition is provided to an administration system, a definition for a virtual node and a virtual link relating to each virtual node configuring the virtual infrastructure is distributed, and each virtual node achieves the virtual infrastructure. Here, the virtual node is a node which is virtual, and is of a concept that is completely different from a virtualized node that is a real node. The virtual node is also referred to as a node sliver. And, the virtual link is also referred to a link sliver.

When a dedicated processor (also referred to as fast path) such as the network processor is used in the virtual node, a program to be loaded to the processor is specified as the slice definition. While the virtual link is not programmable, the network processor is used for implementation of GRE (Generic Routine Encapsulation: IETF standard). Parameters (IP addresses, GRE keys, MAC addresses) for connecting virtual link units inside and outside the virtual node are passed to the network processor when the slice is created. These parameters are provided from the administration system of the virtual node to the network processor via a CLI (Command Line Interface).

### SUMMARY OF THE INVENTION

The following problem arises when a programming depending on a hardware of a network is performed. That is, it is required to write the program so as to be conscious of the hardware of the network processor, and therefore, the following problem arises.

(1) Since the programming becomes difficult, a development cost increased, and a development period is lengthened. Further, since the number of skilled programmers is limited, it is not easy to secure the programmers, either.
(2) The program depends on an unopened individual (unique) technology of a hardware vendor or a software vendor that provides a library or others depending on the hardware. Therefore, it is difficult to obtain knowledge required for the development, and it is difficult to open or deploy results to other companies.

More particularly, for the high-speed (wire rate) packet processing, a programming that appropriately stores the packets in the SRAM and the DRAM and consciously recognizes which one of the memories (SRAM and DRAM) stores the data is required. More particularly, when such a processing as editing (adding, deleting, and/or changing) a header of the packet is required, it is desired to store the header of the packet into the SRAM and store a latter part (remaining part) without the requirement of the processing into the DRAM. This is because the mounting of the SRAM having the memory capacity large enough to store the entire packet (header and remaining part) on the network processor or others is extremely difficult in view of the cost or others. Further, if the header of the packet has not been stored in the SRAM, it is required to access the DRAM when the header of the packet is processed. The access to the DRAM takes time longer than access to the SRAM. That is, the access time to the DRAM is longer than that to the SRAM. Accordingly, when the header that has been stored in the DRAM is to be processed, the processing at the wire rate is impossible due to the relatively long access time to the DRAM.

Therefore, it is desired to provide a program capable of performing the high-speed packet processing not depending on the hardware such as the SRAM and the DRAM but following the opened language specification. And, it is desired to provide an environment in which such a program can be developed. More particularly, in the program, it is desired to eliminate the requirement for distinguishing the SRAM and the DRAM, and besides, to manage by a programming language processing system to recognize which one of the SRAM and the DRAM has the data to be processed. Also in the data transfer between the SRAM and the DRAM, the load on the programmer is reduced by the automatic processing by the processing system, so that the cost required for the programming can be reduced. Further, the further reduction in the cost can be achieved by providing the program not depending on the unopened individual technology.

In consideration of the edition of the header of the packet, the consistent usage of only the SRAM or only the DRAM as described in the Patent Document 1 is inappropriate for the high-speed processing. Therefore, it is desired to provide a developing environment in which the memory (SRAM or DRAM) appropriate for processing the packet can be selectively used and in which an object program enabling the data transfer between the memories can be created.

Neither the Patent Document 1 nor the Non-Patent Document 1 suggests the matter that it is not required for the program when the packet is processed to distinguish in which one of the memories the data to be processed is stored.

A preferred aim of the present invention is to provide a method of processing a program enabling a programming with low dependency on a hardware (SRAM, DRAM, and others).

The above and other preferred aims and novel characteristics of the present invention will be apparent from the description of the present specification and the accompanying drawings.

The typical summary of the inventions disclosed in the present application will be briefly described as follows.

That is, a data representation is added to a packet in accordance with a memory in which the packet is to be stored or has been stored. For example, one data representation out of four types (four states) is added to the packet depending on a type of the memory (SRAM or DRAM) and a part (segment) of the packet to be stored in the memory.

For example, when only the SRAM is used as the memory and stores the entire packet, a data representation “cached” is added to the packet. Further, when only the DRAM is used as the memory and stores the entire packet, a data representation “uncached” is added to the packet.

A data representation “mixed” is provided to a packet the entire of which is stored in the DRAM but only a head part of which is cached in the SRAM. A data representation “fragmented” is added to a packet which is separated so that its separated part is partially stored in the SRAM while the remaining part is stored in the DRAM.

In the processing (operation) for the packet, the data representation added to the packet is identified, and a processing is executed in accordance with the identified data representation. In this manner, a program for processing the packet can be made as the program with the low dependency on the hardware (SRAM and DRAM).

In one embodiment disclosed in the present application, change in the data representation caused by the operation for the packet is estimated by a state transition. In a method of processing a program for developing the program, a unique object program corresponding to the estimated data representation is created. In this manner, the development can be efficient. Also, if the estimation is impossible, by inserting a code for calling attention into the object program at the execution, the development can be further efficient.

In the present application, each of the above-described data representation is used for the identification, and therefore, can be regarded as an identifier. The identifier is provided for each of the packets. Note that the term of “data representation” is also simply referred to as “representation” in the present application.

The effects obtained by typical aspects of the present inventions disclosed in the present application will be briefly described below.

A method of processing a program enabling a programming with a low dependency on a hardware can be provided.

### BRIEF DESCRIPTIONS OF THE DRAWINGS

FIG. 1 is a physical configuration diagram of a network according to one embodiment of the present invention;

FIG. 2 is a configuration diagram of a virtual network according to one embodiment of the present invention;

FIG. 3 is a configuration diagram of a compiler according to one embodiment of the present invention;

FIG. 4 is a diagram illustrating a content of a source program according to one embodiment of the present invention;

FIG. 5 is a diagram illustrating a content of an intermediate language program according to one embodiment of the present invention;

FIG. 6 is a diagram illustrating a data representation of a packet according to one embodiment of the present invention;

FIG. 7 is a diagram illustrating a state transition among data representations of a packet according to one embodiment of the present invention;

FIG. 8A is a flowchart illustrating a procedure of a substring operation which is a part of an object program according to one embodiment of the present invention;

FIG. 8B is a flowchart illustrating a procedure of a subpacket operation which is a part of the object program according to one embodiment of the present invention;

FIG. 8C is a flowchart illustrating a procedure of a concat operation which is a part of the object program according to one embodiment of the present invention;

FIG. 9 is a configuration diagram of a packet according to one embodiment of the present invention;

FIG. 10 is a conceptual diagram of a virtual network; and

FIG. 11 is a configuration diagram of a network processor.

### DESCRIPTIONS OF THE PREFERRED EMBODIMENTS

Hereinafter, an embodiment of the present invention will be described in detail based on the accompanying drawings. Note that the same components are denoted by the same reference symbols in principle throughout all drawings for describing the embodiment, and the repetitive description thereof will be omitted.

### Embodiment

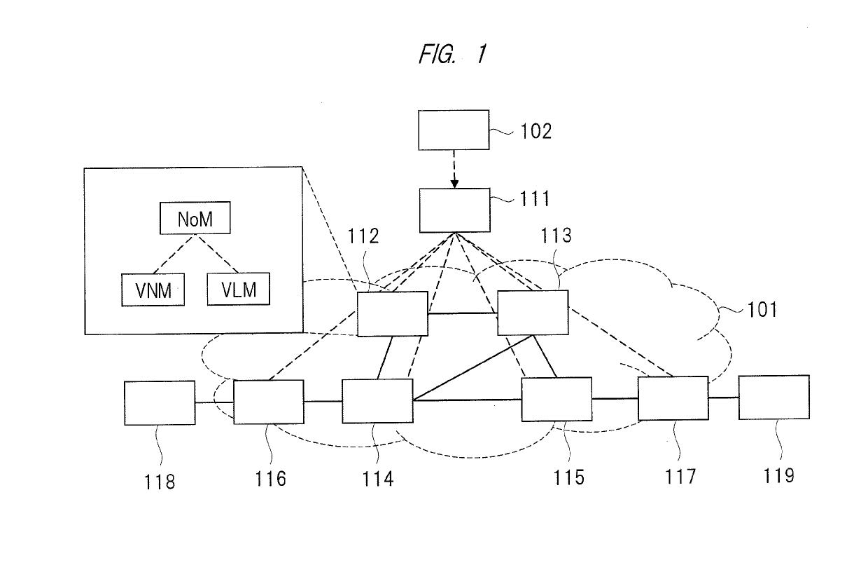

An embodiment according to the present invention will be explained. First, a physical configuration of a network using a network processor will be explained by using FIG. 1. FIG. 1 is a configuration diagram illustrating a physical configuration of the entire network for performing an experiment of the virtual network and others. In this drawing, a numerical symbol “101” surrounded by a broken line denotes a network virtual infrastructure, a numerical symbol “102” denotes an operator console, a numerical symbol “111” denotes a network management server (network manager), and numerical symbols “112” to “115” denote physical nodes. The virtual network further includes gateways 116 and 117, and personal computers (hereinafter, each referred to as PC) 118 and 119 are connected to the above-described gateways 116 and 117, respectively. In this embodiment, each of the physical nodes 112 to 115 is exemplified by the physical node 112, and includes a node manager “NoM”, a virtual node manager “VNM”, and a virtual link manager “VLM”.

<Realistic Network and Slice>

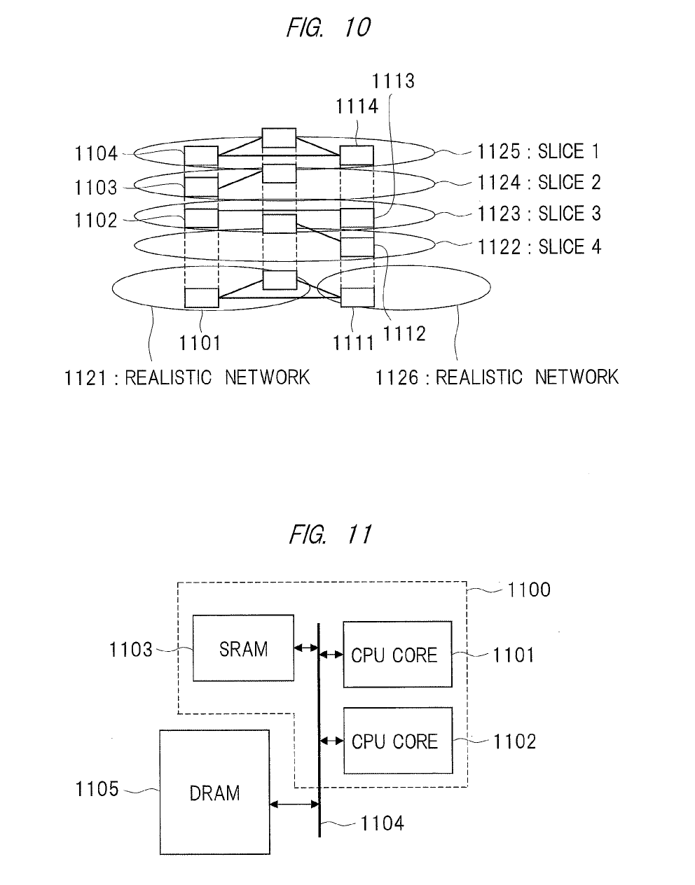

Hereinafter, in a case of handling the virtual network by management information, a relation between a realistic network and the virtual network, that is, and a slice will be explained by using FIGS. 1 and 10. In FIG. 10, numerical symbols “1121” and “1126” denote the realistic networks, and physical nodes “1101” and “1111” are provided on the realistic networks 1121 and 1126, respectively. A virtual network created on these realistic networks includes a plurality of slices 1122, 1123, 1124, and 1125 (slice 4 to slice 1). Virtual nodes 1102, 1103, and 1104 are created on the physical node 1101, and virtual nodes 1112, 1113, and 1114 are created on the physical node 1111.

The created virtual nodes 1104 and 1114 belong to the slice 1125, and are coupled to each other by a virtual link. Similarly, the virtual nodes 1102 and 1113 belong to the slice 1123, and are coupled to each other by a virtual link. Although each configuration of the slices can be the same as that of the realistic network, the slice can have a different configuration from that of the realistic network since the virtual links can be created by using a tunnel or others so as not to be restricted by a physical link.

<Slice and Slice Information>

The slice is generally created by a plurality of virtual nodes and virtual links (virtual data transfer paths) for connection among the virtual nodes. While the virtual node is created on the physical node, the connection among the virtual nodes is independent from the connection among the physical nodes. That is, the virtual link is not restricted by the real link. While each virtual node includes network protocol processing functions such as switching and routing, these functions can be independent from protocol processing functions of the physical node including this virtual node.

In order to set the virtual network which bridges between domains, in the present embodiment, configuration information of the slice which is formed of a list of the virtual node and a list of the virtual link is contained in a management message as slice information. The slice information is information formed of an attribute of the virtual node in such a virtual network as described above, a resource amount thereof, an attribute of the virtual link, and/or a connection relation between the virtual node and the virtual link. Here, the resource amount of the virtual node is, for example, information relating to the number of processors (network processors: CPUs) corresponding to the virtual node and relating to a memory capacity of the memory. Also, the attribute of the virtual link is, for example, information relating to a band that can be used by the virtual link. However, it is not always required for the slice information to contain the information of all of the virtual nodes and virtual links included in the slice.

Also, the slice information is not always the information relating to the virtual network. The information may be, for example, information for managing the physical node or the physical link (realistic data transfer path). In this case, the slice information contains information relating to setting information or a state of the physical node, information relating to a state (such as availability or traffic amount) of the physical link, or others.

<Content of Slice Information>

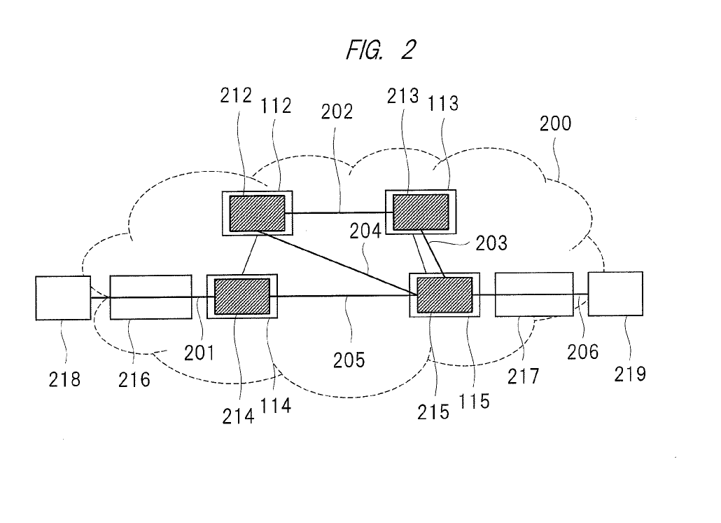

The slice information of a slice “S” that is used in the present embodiment will be explained by using FIG. 2. The slice S is a virtual network on which a new protocol (hereinafter, referred to as “non-IP protocol”) that is not restricted by Ethernet (Trade Mark) or an internet protocol (IP) is experimented. The slice information is provided to a network management server 111 (FIG. 1) via a console 102 (FIG. 1). At this time, the slice information is created and used in a format such as XML (Extensible Markup Language). In order to easily understand here, the slice information is illustrated by using a diagram. However, there is no essential difference.

The slice S (virtual network 200) is formed of a virtual node (1) 213, a virtual node (2) 212, a virtual node (3) 215, a virtual node (4) 214, and gateways 201 and 206. In this embodiment, the virtual node (4) 214 and a user PC 218 via the gateway 216 are coupled to each other by the virtual link (1) 201. The virtual node (1) 213 and the virtual node (2) 212 are coupled to each other by the virtual link (2) 202, and the virtual node (1) 213 and the virtual node (3) 215 are coupled to each other by the virtual link (3) 203. Similarly, the virtual node (2) 212 and the virtual node (3) 215 are coupled to each other by the virtual link (4) 204, the virtual node (4) 214 and the virtual node (3) 215 are coupled to each other by the virtual link (5) 205, and the virtual node (3) 215 and the user PC 219 via the gateway 217 are coupled to each other by the virtual link (6) 206. Although not particularly limited, the virtual node (1) 213 is created within the physical node 113 (FIG. 1), the virtual node (2) 212 is created within the physical node 112 (FIG. 1), the virtual node (3) 215 is created within the physical node 115 (FIG. 1), and the virtual node (4) 214 is created within the physical node 114 (FIG. 1). Note that FIG. 2 illustrates an example in which the physical node 112 (FIG. 1) and the physical node 114 (FIG. 1) are connected by the physical link, and in which the physical node 113 and the physical node 115 are connected by the physical link. In FIG. 2, the physical link is illustrated by a thin line while the virtual link is illustrated by a thick line.

The virtual node (1) 213, the virtual node (2) 212, the virtual node (3) 215, and the PC 219 are nodes for processing the non-IP protocol. However, in the present embodiment, the PC 218 cannot handle the non-IP protocol while only the Ethernet can handle it. Therefore, a network processor which is a processor provided in the virtual node (4) 214 is used to delete a MAC (Media Access Control) header from a packet received from the PC 218 and to transfer the packet to the virtual node (3) 215. On the other hand, when the network processor of the virtual node (4) 214 receives a packet from the virtual node (3) 215, the network processor of the virtual node (4) 214 adds the MAC header to the received packet, and transfers the packet to the PC 218. That is, the network processor on the virtual node (4) 214 operates a program for editing (adding and/or deleting) the MAC header.

Regarding this program, the program using the high-level language is developed by a developer, is translated into the object program by using the compiler, is loaded onto the above-described network processor (the processor on the virtual node (4)), and is executed.

<Configuration of Compiler>

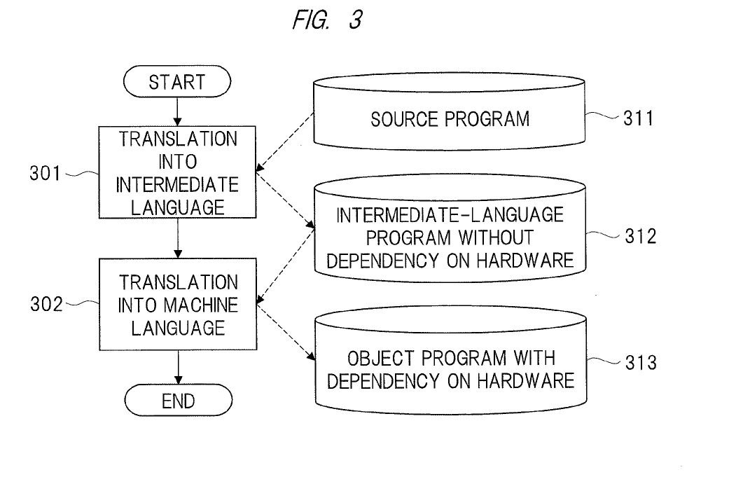

Next, a configuration of the compiler for compiling the program to be loaded to the network processor on each of the virtual node (1) 213, the virtual node (2) 212, the virtual node (3) 215, and the virtual node (4) 214 will be explained by using FIG. 3.

The compiler of the present embodiment is a software for translating a packet-processing high-level language in a Java (Trade Mark)-like format into an object program that is executable by the network processor. When a source program 311 created by the developer is provided to the compiler, the source program is translated into an intermediate language program 312 in step 301. The translated intermediate language program 312 is a program with no dependency on the hardware. That is, an intermediate language program 312 without the dependency on the hardware is created. The intermediate program 312 is then translated into an object program 313 for the network processor in a step 302 for the translation into an object program.

The object program 313 is a program with the dependency on the hardware (physical configuration) of the network processor. That is, in step 302, the object program 313 for selectively using the plurality of data representations is created in consideration of a property of the network processor. For example, an abstract data structure that had been written in the source program 311 is translated into a data structure on the hardware of the network processor, that is, data on the SRAM, data on the DRAM, the descriptor, or others. Also, an executable statement that had been written in the source program 311 is translated into a C language or a machine language format with the vendor-unique specification. In the present embodiment, a procedure of the compiler is formed of two steps. However, the compiler can be executed in one step, or executed by a procedure having three or more steps including an optimization step or others.

<Language Specification>

In the present embodiment, the packet processing program is written in so-called high-level language. This high-level language is similar to Java but is different from an existing high-level language. Hereinafter, the packet processing program language that is used in the present embodiment will be referred to as “S”. Hereinafter, a specification of the language S will be described.

In the language S, a class (data type) representing a packet is defined. By defining a natural operation for a class (hereinafter, referred to as “packet”) of the language S, the packet processing program is created. The packet processing for the existing high-level languages has been defined in accordance with a specific protocol such as Ethernet, IP, TCP, or UDP in many cases. On the other hand, in the language S, in order to write the packet processing by any protocol, the packet is regarded as a byte string, and the packet processing is executed as a processing for the byte string. However, in the packet processing, such an operation as not being restricted by a byte boundary is executed in a state in which a substring is extracted as a character string from the packet. That is, an operation for the packet is not defined. In this manner, any protocol can be handled, so that, for example, a degree of freedom of the protocols used for the virtual network can be improved.

The character string is generally one type of the byte strings, and a basic operation for the character string is substring creation and concatenation. The substring creation is an operation for creating a partial substring from the character string containing the partial substring, and the concatenation is an operation for coupling a plurality of character strings.

In the packet processing, two types of the substring creating operation are generally performed. The first one of them is an operation for extracting a part of packet headers from an input packet, and the second one is an operation for extracting a packet main body, that is, a part from which the part of packet headers is removed, from the input packet. It is desired to optimize these operations so as to be executable at a high speed (wire rate) as fast as possible. Other substring creating operations such as an operation for extracting the middle part of the packet is also possible. However, in the present embodiment, the improvement in the performance of the compiler is not taken into consideration for such an operation.

These two types of the operations can be regarded as being the same as each other as the operation for the byte string. However, it is natural to distinguish the packet header from the packet main body in the packet processing, and therefore, these operations are distinguished from each other in the language S so that the above-described first operation is referred to as “substring” while the above-described second operation is referred to as “subpacket”. A substring operation for the character string is also provided to the language S, and therefore, the following three methods (1) to (3) are provided. Here, each of the terms “from” and “to” is a non-negative integer (integer that is not negative).

(1) “Packet Packet. subpacket (from)”: this method (operation) performs an operation of “returning a substring from the middle part of the packet to a tail thereof as a packet”. Note that the middle part is indicated by the term “from”.

(2) “String Packet. substring (from, to)”: this method performs an operation of “returning a substring in the middle part (range from “from” to “to”) of the packet as a character string”.

(3) “String String. substring (from, to)”: this method performs an operation of “extracting and returning a middle part (range from “from” to “to”) of the character string as a substring”.

Note that a performance of the above-described second method (2) is secured only when a part of the packet indicated by the term “to” exists on the SRAM. In a case that the part exists on only the DRAM, either one of the following two methods can be adopted. The first one is a method of loading the substring from the DRAM to the SRAM although the performance is reduced. The second one is a method of handling the case as an error. In this second method, if a value of the term “to” can be judged when the program written in the language S is compiled, the case can be regarded as the error in the compiling. However, if this value cannot be judged in the compiling, the error is provided when the object program obtained by the compiling is executed. That is, an execution error of the object program is provided.

The concatenation operation of the packet processing is generally an operation for concatenating the packet header with the packet main body. One packet header or a plurality of packet headers is/are provided, and the performance is ensured only when the packet headers all of which are the character strings exist on the SRAM. In the concatenation operation, the packet main body is not required to exist on the SRAM. A concatenation operation for the character string is also provided in the language S, and therefore, the following two methods are provided.

(4) “Packet Packet. concat (String)”: this method performs an operation of “coupling a packet indicated in String with a packet and returning the coupled packet as a packet”.

(5) “String String. concat (String)”: this method performs an operation of “coupling a character string indicated in String with a character string and returning the coupled character string as a character string”.

The concatenation for three or more character strings and packets can be achieved by the repeat application of these methods (4) and (5). Note that a head part of each of the above-described methods (1) to (5) indicates a data type obtained by the operation, an intermediate part thereof indicates a data type prior to the operation, and a later part thereof which is after a symbol “.” indicates a content of the operation. For example, when the above-described method (5) is exemplified, the head part is “String” indicating the fact that the data type of the data obtained by executing this method is the character string. Further, the intermediate part before the symbol “.” is “String” indicating the fact that the data type of the data prior to the operation is the character string. The later part after the symbol “.” is “concat (concatenation)” meaning the coupling.

<Source Program>

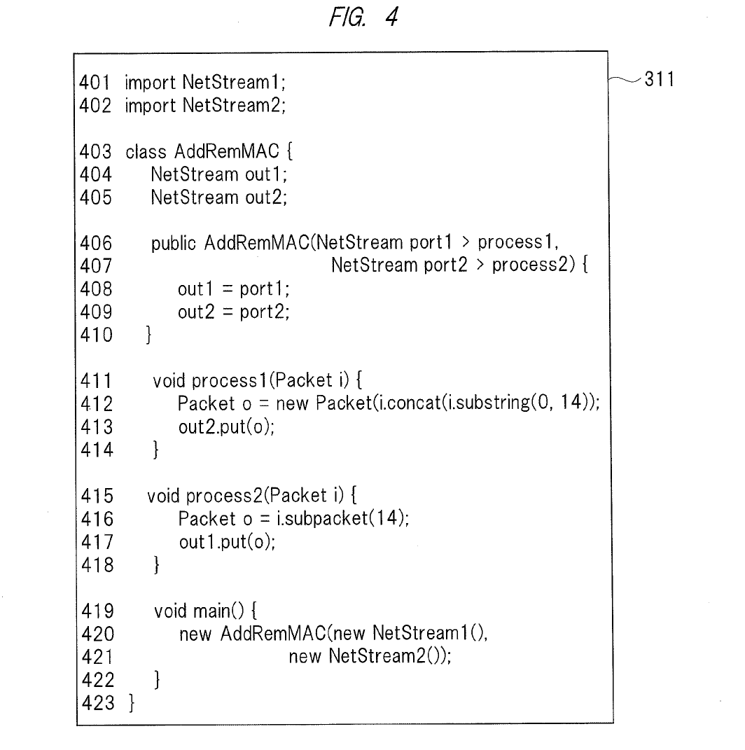

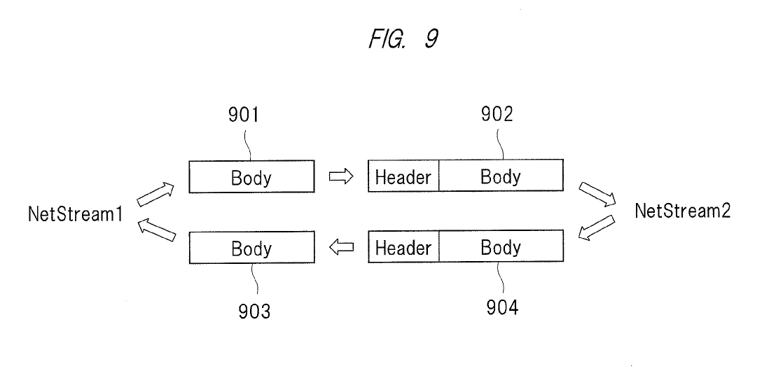

The compiler can translate source programs having various contents. FIG. 4 illustrates one example of a source program as the numerical symbol “311”. This program is a program for reducing a difference in the packet data representation between the inside of the virtual network 200 and the PC 218 (FIG. 2) in the virtual network 200 (FIG. 2). That is, this program inputs and outputs data streams named “NetStream1” and “NetStream2”. Processing for the data streams NetStream1 and NetStream2 are schematically illustrated in FIG. 9. A processing executed by the program 311 will be explained with reference to FIG. 9.

By the program 311 (FIG. 3), a packet header (MAC header: Header) is added to a packet 901 inputted from the virtual node (3) 215 (FIG. 2) via the NetStream1, and the packet is outputted as a packet 902 to the PC 218 (FIG. 2) via the NetStream2. On the other hand, by the program 311, the packet header (MAC header: Header) is deleted from a packet 904 inputted from the PC 218 via the NetStream2, and the packet is outputted as a packet 903 to the virtual node (3) 215 via the NetStream1. In this manner, the packet transmission/reception is possible between the PC 218 that does not handle the non-IP protocol and the virtual network 200 (FIG. 2) with the non-IP protocol.

Next, the meaning of the program 311 will be explained for each part. As illustrated in FIG. 9, this program has two packet input/output (network interfaces) NetStream1 and NetStream2, and is such a program that the MAC header (Header) is added to the packet inputted from the NetStream1, and the packet is outputted to the NetStream2, while the MAC header (Header) is deleted from the packet inputted from the NetStream2, and the packet is outputted to the NetStream1.

While a row number is put at the beginning of each row in the source program 311 (FIG. 4), this number is not contained in the original source program but is added for convenience of explanation. The source program 311 is configured of import declarations 401 and 402 and class declarations 403 to 423. The import declarations 401 and 402 declare that this program inputs and outputs the packet streams NetStream1 and NetStream2, respectively.

In the class declarations 403 to 423 of a class “AddRemMAC”, first, variable declarations 404 and 405 declare variables “out1” and “out2” for the packet stream. A contractor for creating an object of the class AddRemMAC is declared in the rows 406 to 410. Arguments “port1” and “port2” declared in the row 406 indicate a packet stream through which the created object of the class AddRemMAC is transmitted and received. A packet inputted to the stream port1 is processed by such a method as “process1” written immediately after a symbol “>”, and a packet inputted to the stream port2 is processed by such a method as “process2” written immediately after a symbol “>”.

In the rows 408, 409, the stream port1 is assigned to the variable out1, and the stream port2 is assigned to the variable out2. That is, in the class AddRemMAC, the packet outputted to the out1 is outputted to the stream port1, and the packet outputted to the out2 is outputted to the stream port2.

The process1 method is defined in the rows 411 to 414. That is, in the process1 method, a packet “i” is received as the argument as written in the row 411, and a packet is inputted as “i” by executing the process1 for each input of a stream element, that is, the packet to the port1. In the row 412, substrings from the beginning (byte 0) of the packet i to the fourteenth byte thereof are created first as a character string by (i. substring (0, 14)), the created character string and the packet i are concatenated by the concat operation, and the concatenated packet is created by “new Packet ( )”. This created packet is assigned to “o”, and is outputted to the stream out2 in the row 413.

The process2 method is defined in the rows 415 to 418. That is, in the process2 method, a packet “i” is received as the argument as written in the row 415, and a packet is inputted as “i” by executing the process2 for each input of a stream element, that is, the packet to the port2. In the row 416, substrings from the fourteenth byte of the packet I to the end thereof are created first as a packet by (i. subpacket (14)). The created packet is assigned to “o”, and is outputted to the stream out1 in the row 417.

A function “main” defined in the rows 419 to 422 is executed when an instance (singleton) which is unique in the class AddRemMAC is created. In the rows 420 and 421, objects corresponding to the NetStream1 and the NetStream2 are created, and are connected to an external network. These objects are passed to a constructor of the class AddRemMAC. That is, the input from the NetStream1 is processed by the method process1, and an output from the method is outputted to the NetStream2. On the other hand, the input from the NetStream2 is processed by the method process2, and an output from that is outputted to the NetStream1.

In the above-described source program 311, “i. substring (0, 14) in the row 412 corresponds to the above-described method (2), and “i. concat ( )” in the same row 412 corresponds to the above-described method (4). Further, “i. subpacket (14)” in the row 416 corresponds to the above-described method (1).

<Intermediate Language Program>

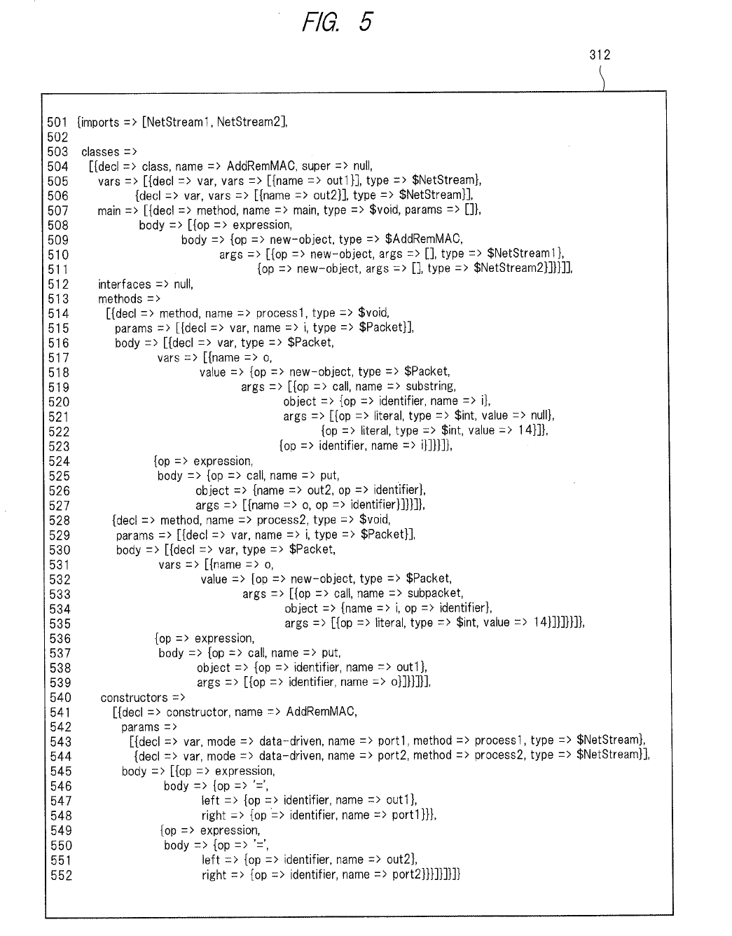

FIG. 5 illustrates an intermediate language program 312 that is obtained by translating the source program 311 of FIG. 4. While the intermediate language program 312 is written in a character string format in FIG. 5, the program is practically data having a tree structure. That is, representation {key1=>value1, key2=>value2, . . . } shows that a value of child data labeled as “key1” is “value1” in a tree node (parent data), and a value of child data labeled as “key2” is “value2”, and shows that the following child data is similarly represented.

The intermediate language program 312 is a program without the dependency on the hardware as similar to the source program 311 (FIG. 4). The rows 401 and 402 of the source program 311 (FIG. 4) are translated into a row 501 of the intermediate language program 312 (FIG. 5). The rows 403 to 423 of the source program 311 (FIG. 4) are translated into rows 503 to 552 of the intermediate language program 312 (FIG. 5). That is, the rows 404 and 405 (FIG. 4) are translated into the rows 505 and 506 (FIG. 5), the rows 406 to 410 (FIG. 4) are translated into the rows 540 to 552 (FIG. 5), and the rows 411 to 414 (FIG. 4) are translated into the rows 514 to 527 (FIG. 5). Similarly, the rows 415 to 418 (FIG. 4) are translated into the rows 528 to 539 (FIG. 5), and the rows 419 to 422 (FIG. 4) are translated into the rows 507 to 511 (FIG. 5).

The translation by the step 301 (FIG. 3), that is, the translation from the source program 311 (FIG. 4) into the intermediate language program 312 (FIG. 5) is performed for converting a syntax of various source programs that are mainly written by the character strings into a united tree structure in the step 301 as similar to that in a normal compiler.

<Packet Data Expression>

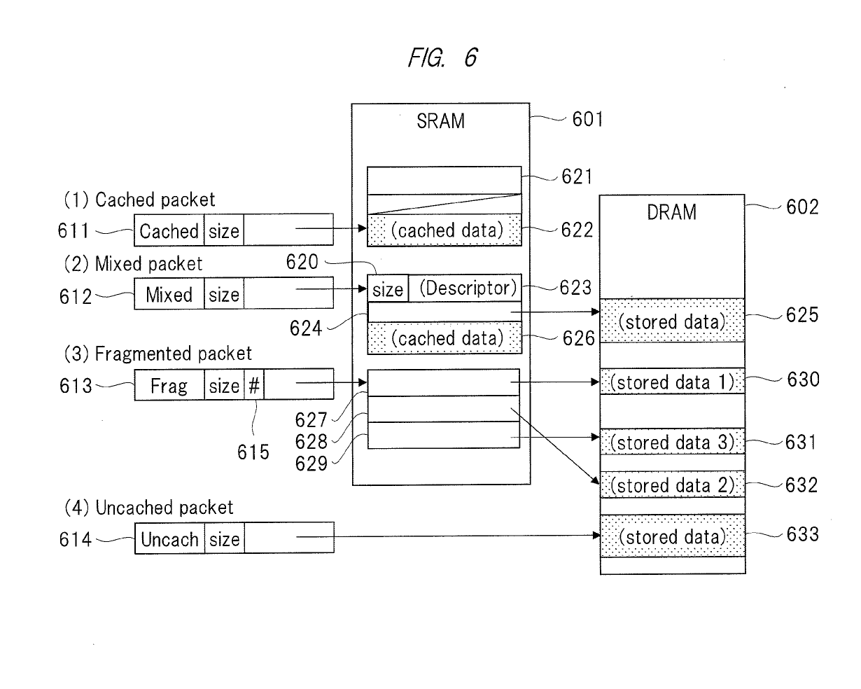

FIG. 6 illustrates four types of packet data representations in the network processor. Before explaining the four types of packet data representations, a configuration of the network processor will be explained. FIG. 11 is a block diagram illustrating the configuration of the network processor that is used in the present embodiment.

In FIG. 11, a numerical symbol 1100 indicates a network processor that is configured as a single semiconductor integrated circuit device although not particularly limited. The network processor 1100 is provided with a plurality of processor (CPU) cores 1101 and 1102, an SRAM 1103, and a data bus 1104. The above-described CPU cores 1101 and 1102 and the SRAM 1103 are connected to each other via the data/address bus 1104. Also, a DRAM 1105 is provided at outside of the semiconductor integrated circuit device which is the network processor 1100, and the DRAM 1105 is also connected to the above-described data/address bus 1104. Although not particularly limited, a program for operating the CPU cores 1101 and 1102 are also stored in the DRAM 1105. The processing device can be regarded as being configured by the network processor 1100 and the DRAM 1105.

The CPU cores 1101 and 1102 perform a processing for the packet or others by using the SRAM 1103 and the DRAM 1105 in accordance with the program stored in the DRAM 1105.

Access time to the SRAM 1103 is faster than that to the DRAM 1105. However, a memory capacity that can be embedded into the semiconductor integrated circuit device is limited. That is, due to suppression of increase in a cost of the network processor 1100, it is difficult to embed an SRAM having a large memory capacity into the network processor 1100. While the SRAM can be also provided at the outside of the network processor 1100 as similar to the DRAM, a cost of an SRAM having the same memory capacity as that of the DRAM is higher than that of the DRAM. Therefore, even the provision of the SRAM at the outside of the network processor 1100 is limited in view of the increased cost.

For example, an object program for packet processing is stored in the above-described DRAM 1105. In this case, the object program is created as explained with reference to FIG. 3. This DRAM 1105 can be regarded as a memory medium in which the program (object program for packet processing) has been stored.

The explanation returns to FIG. 6 and is made for the four types of packet data representations. The four types of packet data are of the same data type (packet). Therefore, these types of packet data are objects belonging to the same class and data of the same type as each other in the source program. However, in the present embodiment, different representations are used in accordance with a packet size, a packet input condition, or a packet processing condition for the aim of high-speed processing of packets. In FIG. 6, a numerical symbol 601 indicates a memory space of the SRAM (for example, 1103 in FIG. 11), and a numerical symbol 602 indicates a memory space of the DRAM (for example, 1105 in FIG. 11). Upon the reception of the packet or the operation of the packet, the data (for example, “Header” and “Body” as illustrated in FIG. 9) configuring the packet are stored in the SRAM and/or the DRAM.

The above-described four types of data representations include (1) (Cached) representation, (2) (Mixed) representation, (3) (Fragmented) representation, and (4) (Uncached) representation. Hereinafter, the above-described item (1) is also referred to as Cached representation, (2) is also referred to as Mixed representation, (3) is also referred to as Fragmented representation, and (4) is also referred to as Uncached representation.

(1) A packet of the Cached representation means a packet which is stored in only the SRAM. In other words, when the entire packet is cached in only the SRAM, the packet is referred to as “Cached representation”. (2) A packet of the Mixed representation is a packet the entire of which is stored in the DRAM and only the head of which is “Cached” in the SRAM. (3) Fragmented representation is provided to a packet which is segmented (divided) into a plurality of fragments so that each fragment is stored in the DRAM. In this case, the fragment is stored in a discontinuous address space in the DRAM. Also, this representation also includes a case in which a part of the fragment is stored in the SRAM. (4) Uncached representation is provided to a packet the entire of which is stored in the DRAM. It is determined which of the four types of representations is provided to a packet by using an identifier contained in a pointer specified by the packet.

In FIG. 6, pointers corresponding to packets and specifying the packets are illustrated as items (1) to (4) on a left side of the drawing. In the same drawing, the item (1) is the packet of the Cached representation (Cached packet), and a pointer specifying this packet is illustrated as a numerical symbol 611, and the item (2) is a packet of the Mixed representation (Mixed packet), and a pointer specifying this packet is illustrated as a numerical symbol 612. Similarly, the item (3) is a packet of the Fragmented representation (Fragmented packet), and a pointer specifying this packet is illustrated as a numerical symbol 613, and the item (4) is a packet of the Uncached representation (Uncached packet), and a pointer specifying this packet is illustrated as a numerical symbol 614.

Each of the pointers 611, 612, 613 and 614 has a field for storing the identifier indicating which representation the pointer shows, a field for storing size information (size) indicating a size of the packet, and a field for storing information specifying a storage destination (for example, address) of either the SRAM or the DRAM. Also, in the Fragmented representation, the plurality of fragments are stored in the DRAM (or are partially stored in the SRAM in some cases), and therefore, a field “#” for storing information relating to the number of fragments is provided.

The setting and the determination of which representation is allotted to the packet is selected by either a hardware or a software (that is, a run-time routine and compiler) in the input of the packet. That is, it is determined which part of the packet is to be put into the SRAM and/or the DRAM basically by the hardware of the network processor. In the language S, the representations are adjusted by the software depending on a situation of the processing. The determined or adjusted representation is stored in the field of the pointer corresponding to the packet as the identifier. Although not particularly limited, as the identifier stored in the corresponding field, for example, “Cached” is used for the pointer corresponding to the above-described packet (1), “Mixed” is used for the above-described packet (2), “Frag” is used for the above-described (3), and “Uncach” is used for the above-described (4).

When the data of the packet is stored in the SRAM and/or the DRAM, the data is stored in a structure body formed in the SRAM in the above-described cases (1) and (2) (1103 in FIG. 11). That is, in the case of (1) the packet of the Cached representation, a structure 621 is formed in the address space of the SRAM, and the entire packet is stored as data 622 (cached data) inside the structure 621. Further, in the case of (2) the packet of the Mixed representation, the entire packet is stored in an address area inside an address space 602 of the DRAM (1105 in FIG. 11) as data 625 (stored data). Also, in this case, a structure 623 corresponding to the Mixed representation is formed in an address space 601 of the SRAM. The data of the head part of the packet is cached and stored in the structure 623 as cached data 626. Moreover, in the structure 623, pointer information 624 for specifying an address inside the address space of the DRAM which has stored the entire packet is stored. The structures formed in the above-described items (1) and (2) are specified by the pointers. That is, the structure 621 that is formed so as to correspond to the storage of the packet of the Cached representation is specified by the pointer 611 of the Cached representation, and the structure 623 that is formed so as to correspond to the storage of the packet of the Mixed representation is specified by the pointer 612 of the Mixed representation. In this manner, the structure can be recognized from the pointer in accordance with each representation, so that the storage destination of the packet can be recognized.

When the packet to be stored is the item (3) of the packet of the Fragmented representation, the packet is divided into the plurality of fragments, and therefore, the plurality of fragments are separately stored into addresses inside the DRAM as data (stored data 1 to 3) 630, 632, and 631. Also in this case, into the address space of the SRAM, an array of pointers 627, 628, 629 for specifying the separately-stored addresses inside the DRAM is stored. In this specification, the array formed of the addresses to these fragments is referred to as a pointer array. While all fragments are stored in the DRAM in FIG. 6, a part of or all fragments may be stored in the SRAM in some cases. Also in this case, the stored addresses are maintained by the pointer array. This pointer array is specified by the pointer 613 of the Fragmented representation. Therefore, the data of the separately-stored packet can be recognized from the pointer 613.

When the packet to be stored is the item (4) of the packet of the Uncached representation, the entire packet is stored in the DRAM as data (stored data) 633. In this case, address information for specifying an address of the DRAM which has stored the entire packet is stored in a corresponding field in the pointer 614 of the Uncached representation. In this manner, even in the packet of the Uncached representation, the storage destination can be recognized by the pointer 614.

In FIG. 6, the structures 621 and 623 in the Cached representation and the Mixed representation on the SRAM have the same configuration as each other. However, these structures may have different configurations from each other. For example, “0” is set to the structure 621 as the pointer for specifying the address of the DRAM so that this value is ignored. However, a different value may be set. Also, the structure can represent not only the packet but also the character string. Note that the cashed data is stored in a continuous area in the memory space 601 of the SRAM.

Each of these structures 621 and 623 is referred to as a descriptor in the present specification. As described above, the descriptor is formed on the SRAM, and contains the value of the head part of the packet. Also, the descriptor 623 also contains the pointer for specifying the address of the DRAM. The pointer to the DRAM is not used when the descriptor indicates only the packet of the Cached representation or indicates the character string. When the descriptor contains the pointer to the DRAM, the descriptor contains the size information 620 indicating a data size on the DRAM. Also, in FIG. 6, the pointer 613 of the Fragmented representation contains a field 615 for storing information indicating the number of components “#” of the pointer array.

<State Transition Among Data Representations>

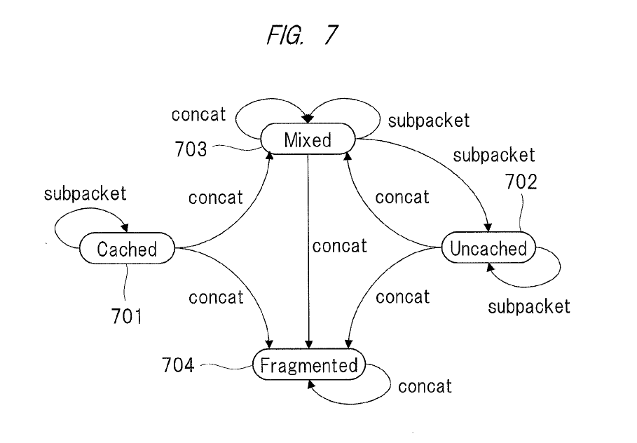

FIG. 7 is a diagram illustrating a relationship in the data representation between an input packet and an output packet in an operation (calculation) of inputting one piece of packet data and of outputting one piece of packet data. In FIG. 7, the data representations are written in a format of such a state transition that they are regarded as states. When the compiler creates a part of the object program 312 (FIG. 3) from the source program 311 of FIG. 4, a relation between a precondition before application of each operation and a post-condition after the application can be recognized by using a data structure that is equivalent to this state transition. This method will be described later. Note that this state transition does not represent a state transition of the entire packet processing program or the entire processor but represents a state transition relating to one packet.

Here, first, application of a subpacket operation to a packet of a Cached state (in which the input packet is of the Cached representation) 701 results in the Cached state. That is, even if the subpacket operation is performed when the entire packet is stored in the SRAM, the entire created packet is always stored in the SRAM. Therefore, the Cached state is maintained.

Second, application of a concat operation to a packed in the Cached state 701 results in a Fragmented state (in which the packet is of the Fragmented representation) 704. That is, when a character string is to be concatenated prior to the packet in the Cached state 701, it is generally impossible to secure a space sufficient to store the character string to be concatenated, immediately prior to the cached data 622 (FIG. 6) of the packet. Therefore, a data representation in the Fragmented state 704 containing two fragments (elements) is created (that is, the state is transited to the Fragmented state 704), and the pointers specifying these pieces of data are stored as the fragments.

Third, application of a subpacket operation to a packet in the Mixed state (in which the packet is of the Mixed representation) 703 results in the Mixed state 703 or an Uncached State (in which the packet is of the Uncached representation) 702. That is, when a part of the data on the SRAM is left by the subpacket operation, the state is transited to the Mixed state 703. When all of the data are removed, the state is transited to the Uncached state 702.

Forth, application of a concat operation to the packet in the Mixed state 703 results in the Fragmented state 704. That is, since the character string to be concatenated cannot be stored immediately prior to the areas of the SRAM and the DRAM storing the packet in the Mixed state 703, it is required to transit (convert) the state to the Fragmented state 704.

Fifth, application a subpacket operation to a packet in the Uncached state 702 results in the Uncached state 702. That is, even if the subpacket operation is performed when the entire packet is stored in the DRAM, the entire created packet is always stored in the DRAM, and therefore, the Uncached state is maintained.

Sixth, application of a concat (new Packet) operation to a packet in the Uncached state 702 results in the Mixed state 703 or the Fragmented state 704. That is, if the character string to be concatenated exists prior to the packet on the SRAM, the original packet exists on the DRAM, and therefore, the Mixed representation can be created by storing the pointer to the DRAM in the descriptor.

Seventh, it is difficult to apply a subpacket operation to a packet in the Fragmented state 704. Therefore, such an operation is not illustrated in the state transition diagram. In such a case, that is, when the subpacket operation is specified, an error is provided or the reduction in the performance is allowed, and a part of the packet data is handled after this is loaded from the DRAM to the SRAM.

<Object Program>

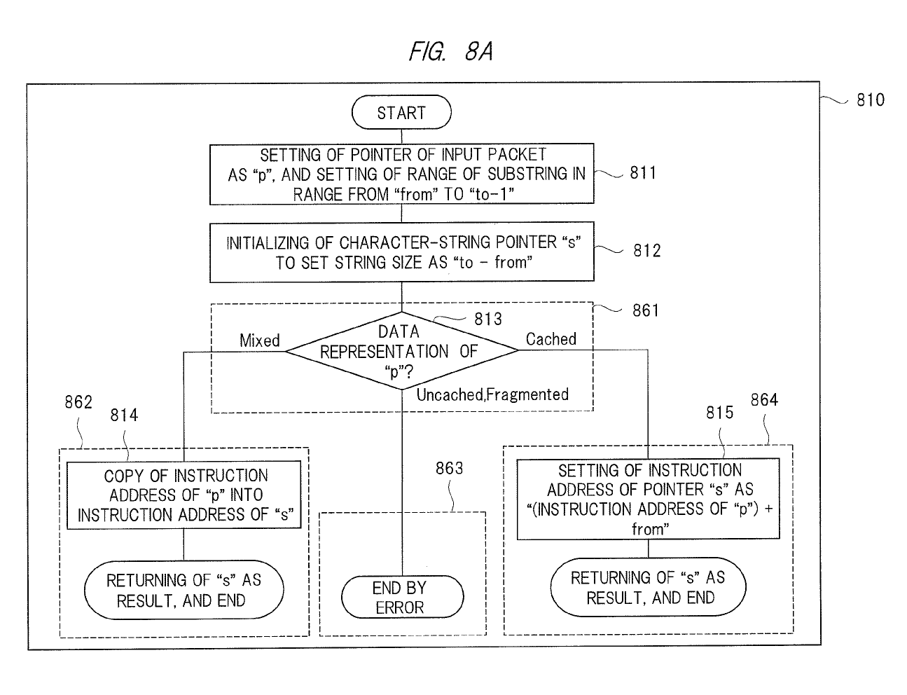

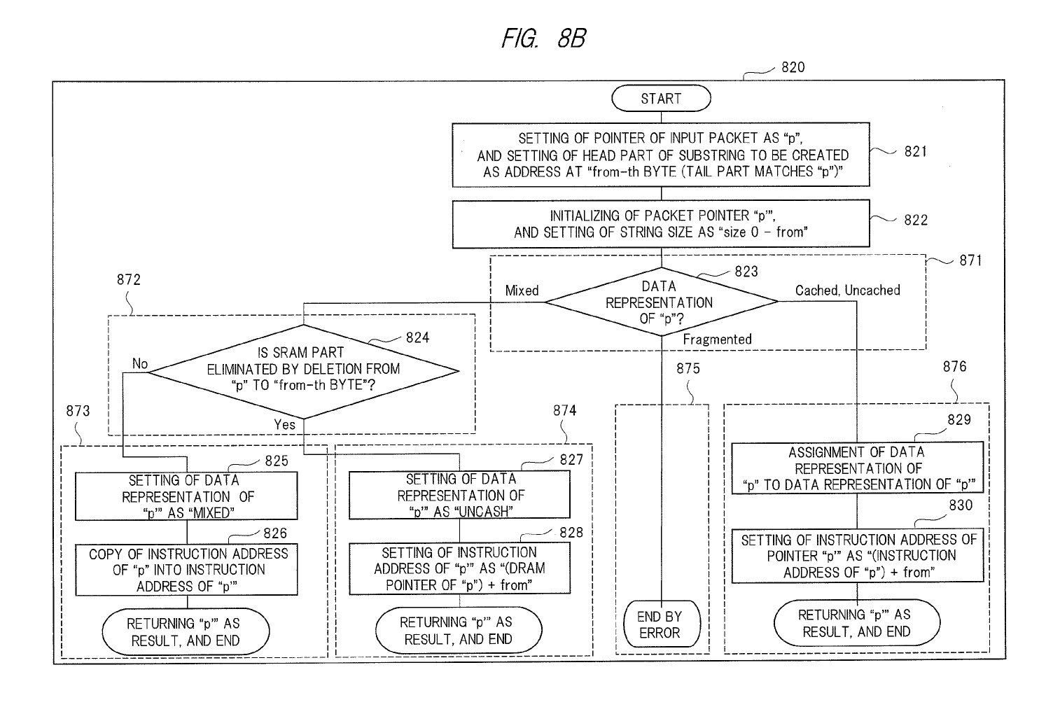

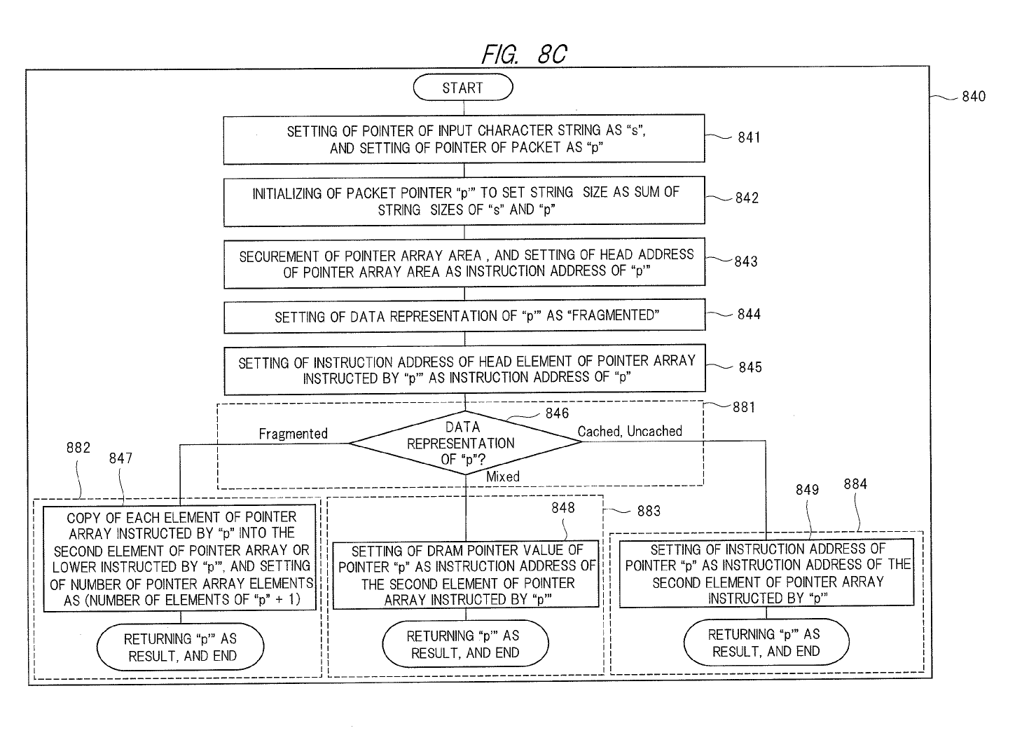

FIGS. 8A, 8B, and 8C are flowcharts illustrating object program templates that are used for creating a part of the object program 313 (FIG. 3) from the source program 311 of FIG. 4. While these object program templates can be also applied when the data representation is unknown in the compiling, they can be partially eliminated when the data representation is determined as any one of “Cached”, “Mixed”, “Uncached” or “Fragmented”. In this manner, a more optimized object program can be created. Also when the data representation is not determined whereas some possibilities can be excluded, a more optimized object program can be created by eliminating parts corresponding to the excluded data representation.

<Object Program Template of Substring>

FIG. 8A illustrates a flowchart of an object program template 810 for the substring operation. The object program template 810 will be explained by using FIG. 8A. To the object program that is represented by this template, a pointer “p” of an input packet in executing this program and data for specifying a range of a substring to be obtained are inputted (step 811). The range of the substring to be obtained is provided as from “from” to “to−1”. The substring operation for the packet corresponds to the above-described method (2). The variables “from” and “to” for specifying the range of the substring to be obtained are provided when the method (2) is invoked. As already explained in the method (2), the variables “from” and “to” are integers that do not become negative. Note that “to−1” means a value obtained by subtracting 1 from the variable “to”. The pointer p means the pointer as explained in FIG. 6. That is, the pointer p has an identifier for indicating Cached, Mixed, Frag or Uncach depending on which one of the Cached representation, the Mixed representation, the Fragmented representation and the Uncached representation the input packet is. Note that the pointer p is also referred to as a packet pointer p in the present specification.

Next, in step 812, a character string pointer “s” is initialized so that a value shown as {the variable “to”−the variable “from”} is assigned into a size field “size” contained in the character string pointer s. That is, the resulting size of the character string is shown as {“to”−“from”}. In step 813, the data representation of the input data is judged from the identifier of the pointer (packet pointer) p of the input packet. When the identifier is “Mixed”, step 814 is executed next. When the identifier is “Cached”, step 815 is executed next. In other cases, that is, when the identifier is “Uncach” or “Frag”, step 863 is executed. In step 863, a predetermined code and is embedded so as to end the execution of the program 313 as a run-time error is embedded. However, if the created program 313 should be executed even if an execution efficiency of the program 313 is reduced, the value of the substring may be loaded from the DRAM to the SRAM, and be returned as a result instead of the end as the error.

In step 814, an address (which is the address for specifying the structure or the pointer array in FIG. 6) contained in the input packet pointer p is copied to an address field that is contained in the character string pointer s. In this manner, the pointer p and the character string s share the same area as each other. However, since the value of the string is not rewritten in the substring operation, the reference of the same area as described above can be performed. When step 814 ends, the value of the character string s is taken as a return value, and the execution of the substring operation ends.

On the other hand, when step 815 is executed, a value obtained by adding the “from” and an address contained in the packet pointer p is assigned into the address field contained in the character string s in step 815. That is, in the packet of the Cached representation, a pointer is returned, the pointer having an address that is advanced by the value of “from” from the address contained in the pointer. Also in this case, the packet pointer p and the character string pointer s share the same area as each other. When step 815 ends, the value of the character string s is taken as a return value, and the execution of the substring operation ends.

In step 811, note that it may be checked whether the value (range) between the provided values “from” and “to” is an appropriate value or not. In such a manner, the error can be pointed out. On the other hand, by eliminating the check as seen in the present embodiment, the efficiency can be achieved.

<Object Program Template of Subpacket>

Next, the meaning of the object program template 820 of the subpacket operation will be explained by using FIG. 8B. To the object program represented by this template packet, the packet pointer p and the “from” indicating the head part of the substring to be obtained are inputted as illustrated in step 821. This object program 820 corresponds to the above-described method (1), and the variable “from” is provided as a non-negative integer. Note that a tail part of the substring to be obtained matches that of the packet pointer p, and therefore, is not inputted.

When the execution starts, a packet pointer p′ is initialized in step 822. After the initialization, a value shown as {size 0−“from”} is assigned into the size field “size” contained in the packet pointer p′. That is, the resulting packet size is set as {size 0−“from”}. Here, the size 0 is a size of the packet that has been indicated by the input packet pointer p, and is a value that is stored in the size field “size” contained in the packet pointer p.

In step 823, the data representation of the input packet pointer p is judged. The data representation is judged by judging the identifier as similar to the above description in FIG. 8A. When the data representation of the input packet is the Mixed representation, step 824 is executed next. And, when the data representation is the Cached representation or the Uncached representation, step 829 is executed next. Other cases, that is, when the data representation is the Fragmented representation, step 875 is executed. In step 875, an error is provided when the object program is executed so as to end the execution of the program 313. However, if the program should be executed even if the execution efficiency is reduced, the value of the substring is loaded from the DRAM to the SRAM, and is returned instead of the end as the error as similar to the above description in FIG. 8A.

In step 824, by executing the subpacket operation, it is judged whether the part stored in the SRAM is completely deleted or not. This judgment is achieved by judgment of whether the part stored in the SRAM has a byte indicated by the “from” or lower. That is, when the part stored in the SRAM has the byte indicated by the “from” or lower, the data from the head part of the packet is stored in only the DRAM by executing the subpacket operation. If it is judged that the data remains in the SRAM unit as the result of this judgment, step 825 is executed next. On the other hand, if it is judged that no data remains therein, step 827 is executed next.

In step 825, the data representation of the packet pointer p′ is set to be the Mixed representation. That is, a value of “Mixed” (for example, an integer value) is assigned into the data representation field of the packet pointer p′ as the identifier. Next, in step 826, an instruction address of the input packet pointer p is copied to a field for storing an instruction address (the structure in the SRAM: the address for specifying the descriptor) contained in the packet pointer p′. That is, in the Mixed representation, the packet pointer p′ should instruct a head part of the descriptor, and therefore, a value of the specific address (a value of the pointer) is not changed. A head position of the packet is represented by a difference between a size (not changed by this operation) contained in the descriptor and a size contained in the pointer p′. When step 826 ends, a value of the packet pointer p′ is taken as a return value, and the execution of the subpacket operation ends.

In step 827, the data representation of the packet pointer p′ is set to be the Uncached representation. That is, a value of “Uncach” (for example, an integer value) is assigned to the data representation field of the point p′ as the identifier. Next, in step 828, the instruction address of the packet pointer p′ is provided by adding a value of the “from” to a value (assumed to “d”) of the pointer to the DRAM contained in the descriptor instructed by the input packet pointer p. Here, the above-described pointer value “d” is a head address of the packet indicated by the input packet pointer p, and therefore, the packet pointer p′ instructs an address at the “from”-th byte from the head part of the packet. When step 828 ends, the value of the packet pointer p′ is taken as a return value, and the execution of the subpacket operation ends.

In step 829, the data representation of the pointer p′ is matched with that of the input packet pointer p. That is, a value stored in the data representation field of the input packet pointer p is assigned into the data representation field of the pointer p′ as the identifier. Next, in step 830, a value obtained by adding the value indicated by the “from” to the instruction address of the input packet pointer p is stored in the field for storing the instruction address of the pointer p′. That is, the instruction address by the input packet pointer p is advanced by only the value indicated by the “from”, and the advanced instruction address is outputted from the pointer p′. When step 830 ends, the value of the packet pointer p′ is taken as a packet pointer to be a return value, and the execution of the subpacket operation ends.

<Object Program Template of Concat>

Next, meaning of an object program template 840 of the concat operation will be explained by using FIG. 8C. In the object program represented by this template, as described in step 841, the pointer “s” of the input character string and the packet pointer “p” of the input packet are provided as the inputs. This object program 840 corresponds to the above-described method (4).

When the execution starts, the packet pointer p′ is initialized in step 842. A sum of sizes that have been stored in each size field of the packet pointers s and p is stored in the size field contained in this pointer p′. That is, a sum of a size that has been stored in the pointer s and a size that has been stored in the pointer p is obtained, and the obtained sum is assigned into the size field of the pointer p′.

In the following step 843, a pointer array area to be returned as a result in the execution of the concat operation is secured and is allocated in the SRAM. A head address of the allocated pointer array area (an address inside the SRAM) is stored in a field of the instruction address in the pointer p′ so that the head address is instructed by the pointer p′. That is, the above-described head address is assigned as the instruction address of the pointer p′. Next, in step 844, the data representation of the pointer p′ is set to be the Fragmented representation. That is, a value of “Frag” (for example, an integer value) is assigned into the data representation field of the pointer p′ as the identifier. In the next step 845, an instruction address of the head element of the pointer array instructed by the pointer p′ is matched with the instruction address of the pointer p. That is, the instruction address contained in the pointer p is assigned to the head element of the pointer array instructed by the pointer p′.

In step 846, the data representation of the previously-input pointer p is judged. This judgment is made similarly to FIG. 8A. If the data representation of the packet pointer p is the Fragmented representation as the result of the judgment, step 847 is executed next. Further, if the data representation of the packet pointer p is the Cached representation or the Uncached representation, step 849 is executed. Meanwhile, if the data representation is the Mixed representation, step 848 is executed next.

If the input packet is in the Fragmented state, the pointer p of this input packet specifies the pointer array. Therefore, in step 847, each element of the pointer array instructed by the packet pointer p is copied to the second element or a subsequent element of the pointer array instructed by pointer p′. That is, the number of elements of the pointer array contained in the pointer p′ is a value obtained by adding 1 to the number of elements of the pointer array contained in the pointer p. When step 847 ends, the value of the pointer p′ is taken as a return value, and the execution of the concat operation ends.

In step 848, a value of the pointer to the DRAM in the descriptor instructed by the input packet pointer p is set to be the second element of the pointer array instructed by the pointer p′, and the number “#” of elements of the pointer array contained in the pointer p′ is set to be 2. When step 848 ends, the value of the pointer p′ is taken as a return value, and the execution of the concat operation ends.

In step 849, the instruction address of the pointer p is set to be an instruction address of the second element of the pointer array instructed by the pointer p′. When step 849 ends, the value of the pointer p′ is taken as a return value, and the execution of the concat operation ends.

<Creation Procedure of Object Program>

Hereinafter, a procedure of translation 302 (FIG. 3) into a machine language will be explained. In the translation 302 into the machine language, the entire intermediate language program 312 (FIG. 3) is translated into the object program 313. While a flow of this translation is similar to that in the conventional compiler, an operation for the packet data in the intermediate language program 312, that is, translation for the method invoking is different from that of the conventional compiler. That is, the method invoking such as the substring operation, the subpacket operation, and the concat operation as contained in the intermediate language program 312 is translated as follows. For the method invoking of them, object program templates 810, 820 and 840 are defined. That is, the object program template corresponding to the method invoking of them is selected, and the program is operated in accordance with the selected template.

At this time, the object program is created by rewriting a variable part of the template immediately before the method invoking in accordance with a possible data representation. A method of creating the object program will be explained for each of the substring operation, the subpacket operation, and the concat operation.

First, a processing of the method invoking for the substring operation will be explained. In the object program template 810 (FIG. 8A), each part of steps 861, 862, 863, and 864 (FIG. 8A) is variable. That is, each part of the steps 861, 862, 863, and 864 can be eliminated or simplified in accordance with a precondition established before application of the substring operation for the object program template 810 that is to be applied. A method for the elimination or the simplification will be explained.

In FIG. 8A, the data representation is judged in step 813, and the processing is performed in accordance with a judgment result. However, such a conditional branch takes relatively long time for calculation, and therefore, the processing at the (high-speed) wire rate may be impossible in some cases. Therefore, it is desired to eliminate such conditional branch for optimization. Three types of the case in which such optimization is possible will be explained below.

The first one is a case in which the compiler recognizes that the representation is always the Cached representation because of the relatively-small input packet size. In this case, it is not required to create the machine language (object program) that corresponds to the steps 813 and 814, and a machine language corresponding to step 815 may be created after step 812. In this manner, the conditional branch can be eliminated. That is, machine languages corresponding to a judging step 861 including step 813, a processing step 862 including step 814 in the case of the Mixed representation, and an error processing step 863 for performing the error processing can be eliminated.

The second one is a case in which the compiler recognizes that a packet which is a target for the substring operation has been applied in such a state that input of the packet from a network has been maintained or recognizes that the packet is inputted from the network. In this case, it is not required to create the case of the end of the program by the error when the compiler recognizes that the packet is not in the Uncached state and the Fragmented state but in either the Cached state or the Mixed state. By eliminating this case, the execution efficiency is increased in either one or both of the Mixed state and the Cashed state in some cases. That is, the judgment of which one of the Uncached state or the Fragmented state the packet in step 861 (Step 8A) is in can be eliminated, so that the error processing step 863 relating to the error processing can be eliminated.

The last one is a case in which the compiler recognizes application of the substring operation immediately after other operation by the program and in which the number of the preconditions can be decreased by using the state transition as illustrated in FIG. 7. When the immediately-previous operation is the concat operation, states after the application of the concat operation in FIG. 7, that is, states each of which a head of an arrow being labeled “concat” in FIG. 7 reaches are only Mixed 703 and Fragmented 704. In this case, the precondition is shown as “Mixed or Fragmented”. That is, the two states of “Cached” and “Uncached” are excluded. In this manner, it is not required to consider Cached or Uncached in the judgment 813 of the judgment step 861, so that the object program from which the step 864 of processing the Cached state is eliminated can be created.

Note that the immediately-previous operation is limited to the concat operation in the above explanation. However, even when the immediately-previous operation is the substring operation or the subpacket operation, the precondition can be obtained by applying the state transition as illustrated in FIG. 7, and the object program can be created in accordance with the precondition.

Next, a processing of the method invoking for the subpacket operation will be explained. In the object program template 820 (FIG. 8B), each part of steps 871, 872, 873, 874, 875, 876 is variable. That is, each part of the steps 871, 872, 873, 874, 875, 876 can be eliminated or simplified in accordance with the precondition established before the application of the subpacket operation to which the object program template 820 is to be applied. The method will be explained below.

In FIG. 8B, the data representation is judged in step 823, and the processing is performed in accordance with the judgment result. However, a case enabling the optimization for eliminating such a conditional branch will be explained below. When the compiler recognizes that the representation is always the Cached representation because of the relatively-small input packet size, it is not required to create steps 823 to 828, and a machine language for executing step 829 after step 822 may be created. In this manner, the conditional branch can be eliminated. That is, the parts of the judgment step 871, the Mixed judgment step 872, the Mixed processing step 873, the Uncached processing step 874, and the error processing step 875 can be eliminated. Note that only the elimination of the condition in the object program has been described here. However, the object program can be simplified by the limitation of the precondition, and more particularly, by the limitation of the immediately-previous operation.

Last, a processing of the method invoking for the concat operation will be explained. In the object program template 840 (FIG. 8C), each part of steps 881, 882, 883, and 884 is variable. That is, each part of the steps 881, 882, 883, and 884 can be eliminated or simplified in accordance with the precondition established before the application of the concat operation to which the object program template 840 is to be applied. One example of the method for the elimination is as follows.

In FIG. 8C, the data representation is judged in step 846, and the processing is performed in accordance with the judgment result. However, a case enabling the optimization for eliminating such a conditional branch will be explained below. When the compiler recognizes that the representation is always the Cached representation because of the relatively-small input packet size, it is not required to create the parts up to steps 881, 882, and 883, and a machine language that corresponds to step 849 after step 845 may be created. In this manner, the conditional branch can be eliminated. That is, the parts of the judgment step 881, the processing step 882, and the error processing step 883 can be eliminated. Note that only the elimination of the condition in the object program has been described here. However, the object program can be simplified by the limitation of the precondition, and more particularly, by the limitation of the immediately-previous operation.

While the method of rewriting the variable parts of the object program templates by using the data representations which can be inputted has been employed in the present embodiment. However, the following method can be alternatively employed. That is, a plurality of object programs or object program templates may be previously prepared, and one of them may be selected in accordance with the data representations which can be inputted. In this case, the selected one can further rewrite the variable parts in accordance with an input condition such as a range of an argument value.

In the above-described embodiment, the increase in the speed of the created machine language (object program) is attempted by simplifying each of the templates 810 (FIG. 8A), 820 (FIG. 8B) and 840 (FIG. 8C). However, the program may be modified by providing the error by operating the object program 313 (FIG. 3), and then, reviewing the source program 311 (FIG. 3) or the intermediate language program 312 (FIG. 3) based on the provided error. That is, based on the run-time error, the program may be reviewed and modified so as to increase the speed.

In this case, the object program contain a code (machine language) for the processing of the substring operation as illustrated in FIG. 8A, a code for the processing of the subpacket operation as illustrated in FIG. 8B, and a code for the processing of the concat operation as illustrated in FIG. 8C. These contained codes are invoked and executed in the program at appropriate timing. In this manner, the error may be provided at the execution in some cases, so that the program can be modified based on the error. In the program, it is of course not required to contain all of the three types of operations. In view of the modification based on the error provided at the execution, it is desired in the object program to contain the codes for the processing of the steps 813 (FIG. 8A), 823 (FIG. 8B) and 846 (FIG. 8C) for judging the data representation. While it is also desired to leave the step for indicating the error at the execution such as step 863 (FIG. 8A) in the object program, other processing for indicating the error can be used as this step.

The created object program (containing the code corresponding to the step for the judgment of the data representation) as described above may be stored in, for example, a storage media and be distributed, or may be stored in, for example, the DRAM 1105 as illustrated in FIG. 11 and be distributed as a network processor. In this case, the DRAM 1105 can be regarded as a storage medium.

The one including the packet and the pointer (611 to 614 in FIG. 6) corresponding to the packet can be also regarded as a packet. In this case, the packet includes the identifier provided to the packet.

In the foregoing, the invention made by the present inventor has been concretely described based on the embodiments. However, the present invention is not limited to the foregoing embodiments and various modifications and alterations can be made within the scope of the present invention.

What is claimed is:

1. A method of processing a program for translating a program written by a high-level language into an object program of a processing device,
wherein the program includes a plurality of procedures including a first procedure which inputs first data of a specific data type and outputs second data of the specific data type, and,
when the first procedure is invoked in the translation of the program, it is judged that the first data at the invoking is either a first representation or a second representation that is different from the first representation, and the first procedure is translated into an object program for applying a first execution method or an object program for applying a second execution method that is different from the first execution method based on the judgment and a condition immediately before the invoking of the first procedure.

2. The method of processing the program according to claim 1,
wherein the specific data type is a packet type,
the first representation represents that the entire packet which is the first data is stored in a continuous memory area, the second representation represents that the packet is stored as being distributed into a plurality of memory areas, and,
when the first procedure is invoked immediately after input of the packet which is the first data which is of the first representation at the invoking of the first procedure, the first procedure is translated into an object program for applying the first execution method, and the second data of the first representation is outputted in execution of the translated object program in the processing device.

3. The method of processing the program according to claim 1,
wherein the specific data type is a packet type,
in the first representation, the entire packet is stored in an SRAM,
in the second representation, a head part of the packet is stored in the SRAM, and a remaining part of the packet is stored in a DRAM,
when the first procedure is invoked immediately after input of the packet which is the first data which is of the first representation at the invoking of the first procedure, the first procedure is translated into an object program for applying the first execution method, the packet which is the second data is stored in the SRAM in execution of the translated object program of the processing device.

4. The method of processing the program according to claim 1,
wherein, when data of the second representation is not formed in a second procedure invoked immediately after the first procedure, the second procedure is translated into an object program for applying the first execution method.

5. A method of processing a program for translating a program written by a high-level language into an object program of a processing device,
wherein the program includes a plurality of procedures including a first procedure which inputs first data of a specific data type and which outputs second data of the specific data type,
each of the first data and the second data contains an identifier indicating information used when the data is stored in a memory, and,
in the translation of the program, by judging the identifier contained in the first data at the invoking when the first procedure is invoked, the first procedure is translated into an object program for applying a first execution method if the identifier is of a first representation, or the first procedure is translated into an object program for applying a second execution method that is different from the first execution method if the identifier is of a second representation that is different from the first representation.

6. The method of processing the program according to claim 5,
wherein the specific data type is a packet type,
the processing device includes a network processor, and an SRAM and a DRAM connected to the network processor, and
the first representation of the identifier represents that all of the data of the packet are stored in the SRAM, and the second representation represents that all of the data of the packet are stored as being distributed in the SRAM and the DRAM.

7. The method of processing the program according to claim 6,
wherein information for specifying an area of the DRAM is stored in the SRAM that is represented by the second representation, and the data distributed from the packet is stored in the specific area of the DRAM.

8. A program that is executed by a network processor for processing a plurality of packets by using a first memory having first access time and a second memory having access time slower than the first access time,
wherein each of the plurality of packets contains an identifier, and the plurality of packets includes a packet containing a first identifier indicating that data contained in the packet is stored in the first memory as the identifier, and includes a packet containing a second identifier indicating that data contained in the packet is stored as being distributed in the first memory and the second memory as the identifier, and
it is judged that the identifier contained in the packet is either the first identifier or the second identifier in an operation for each of the plurality of packets, and different procedures from each other are performed for in accordance with a result of the judgment.

9. The program according to claim 8,
wherein the plurality of packets includes a packet containing a third identifier indicating that data of the packet is stored in the second memory without being distributed, and,
when it is judged in the judgment that the identifier is the third identifier, a procedure different from a procedure for the packet containing the first identifier and a procedure for the packet containing the second identifier is performed.

10. The program according to claim 9,
wherein the program is stored in a memory medium.

11. The program according to claim 9,
wherein the first memory is an SRAM, and the second memory is a DRAM.
